(19) United States
(12) Patent Application Publication
(10) Pub. No.: US 2025/0232624 A1
(43) Pub. Date: Jul. 17, 2025

(54) LOCK TO LOCK COMMUNICATION

(71) Applicant: ASSA ABLOY Access and Egress Hardware Group, Inc., New Haven, CT (US)

(72) Inventors: Christine Voelker, East Hampton, CT (US); Xiaoka Xu, Glastonbury, CT (US)

(73) Assignee: ASSA ABLOY Access and Egress Hardware Group, Inc., New Haven, CT (US)

(21) Appl. No.: 19/012,752

(22) Filed: Jan. 7, 2025

Related U.S. Application Data
(60) Provisional application No. 63/621,523, filed on Jan. 16, 2024.

(51) Int. Cl. G07C 9/00; G08B 25/00; G08B 29/18

(52) U.S. Cl. CPC G07C 9/00309; G08B 25/005; G08B 25/009; G08B 29/188

(57) ABSTRACT

A lock system having locks that can communicate directly with each other or through each other in the case of an emergency. Each lock in the lock system is capable of detecting an emergency by employing a sensor. When the lock detects an emergency, it initiates its own emergency response (e.g., locking doors, sending alarms) and in addition, that lock communicates with other locks so that those other locks can initiate its own emergency response.

### RELATED APPLICATIONS

This Application claims the benefit under 35 USC 119(e) of U.S. Application Ser. No. 63/621,523, filed Jan. 16, 2024, titled “LOCK TO LOCK COMMUNICATION”, the entire contents of which is hereby incorporated by reference herein.

### FIELD

Disclosed embodiments are related to electronic locks and in particular electronic locks that communicate with one another in a network.

### BACKGROUND

Buildings such as schools, offices, or municipal buildings have various emergency response procedures and systems to ensure occupant safety in the event of an emergency, such as an intruder, fire or natural disaster. In the event of an intruder or violent incident in a building, it may be common to initiate a lockdown, where typically entrances to a building and entrances to rooms inside of a building are locked. Administrators, emergency personnel and security are typically able to unlock any door. Some lockdowns involve administrators alerting occupants of an emergency through a building wide intercom system or other communication method. Staff can then manually lock and secure doors to rooms and the building.

### SUMMARY

According to one aspect, a lock system is disclosed. The lock system includes a plurality of locks; a primary lock being one of the plurality of locks. At least one sensor is capable of detecting at least one stimulus and capable of transmitting information to the primary lock. The primary lock is capable of activating at least one primary emergency response and generating at least one emergency signal upon receiving information from the sensor indicating an emergency. At least one secondary lock is another one of the plurality of locks. The primary and secondary locks are in direct communication with each other. The secondary lock is capable of receiving an emergency signal transmitted from the primary lock. The secondary lock is capable of activating at least one secondary emergency response upon receiving the emergency signal from the primary lock.

According to another aspect, a responding lock within a lock system is disclosed. The lock system includes a plurality of locks. One of the plurality of locks is a primary lock and another of the plurality of locks is the secondary lock. The primary lock is capable of activating at least one primary emergency response based upon input from at least one sensor capable of detecting at least one stimulus. The responding lock is configured to be in communication with the primary lock and configured to receive an emergency signal transmitted from the primary lock. The secondary lock is capable of activating at least one secondary emergency response upon receiving the emergency signal from the primary lock.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of a prior art system;

FIG. 2 is a schematic representation of one embodiment lock to lock communication system;

FIGS. 3A and 3B are schematic representations of a building with the lock to lock system of FIG. 2 having an emergency and response according to an embodiment;

FIGS. 4A-4C are flow charts of various embodiments of the lock to lock system of FIG. 2.

FIGS. 5A-5E are flow charts showing various embodiments of emergency detection for the operation of the lock to lock system of FIG. 2.

### DETAILED DESCRIPTION

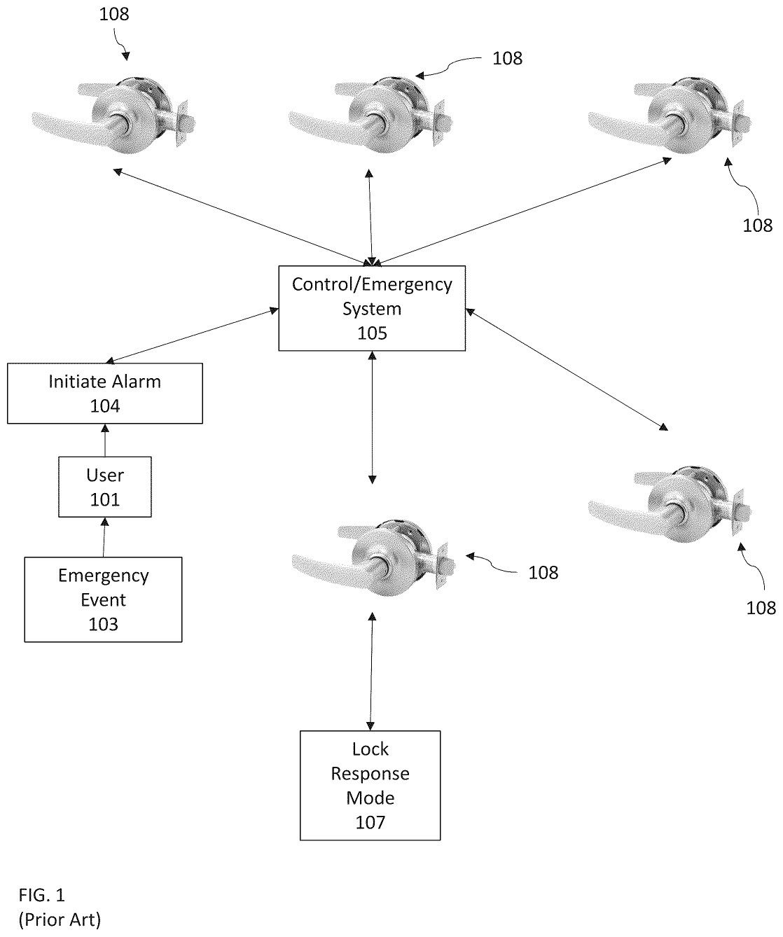

Security is a major concern for buildings and complexes such as schools, offices, or hospitals. These buildings typically have various emergency procedures depending on the type of emergency event. These emergency events may require room doors to be locked, possibly with an alert system and/or any other emergency procedure being implemented. FIG. 1 depicts a prior art arrangement employed in buildings in the event of an emergency where lines represent the flow of information. A user 101 may notice an emergency event 103 and trigger an alarm 104 which may activate an emergency system 105. The emergency system 105 then conveys information to door lock locations 108 so that a response 107 may be initiated to mitigate the emergency event 103 at the door lock location. In the event of an emergency, information does not directly reach a door lock location. Instead, information about the emergency event 103 must travel to a central system 105 before reaching the lock locations 108.

The Inventors have found that the prior art system may lead to delayed response times and the entire response is vulnerable to a failure, given that the information must first flow to the control system 105. Accordingly, the Inventors have invented a system that overcomes these deficiencies.

The Inventors have appreciated that it may be desirable for a lock system to detect emergencies in the vicinity of a lock, having the lock initiate an emergency response and communicate the emergency to other nearby locks. This response may be desirable in a school or office where occupant safety is a high priority and responses to emergencies need to be rapid or localized. A responding lock may detect an emergency and initiate a response to the emergency to reduce the danger of the emergency.

In some embodiments, a lock may be connected to sensors that detect different stimuli in the environment and provide or transmit data to the lock. Stimuli may include, but are not limited to temperature, forces, noise, vibrations, light, or visual motion. It should be appreciated that a sensor may be capable of determining whether the event qualifies as an emergency and communicating the emergency to the lock, alternatively the sensors may communicate to a controller which is responsible for determining whether an emergency is occurring. For example, in one embodiment, a sensor may be configured to detect the ambient temperature. If the temperature exceeds a predetermined threshold indicating a fire or unsafe temperatures, the sensor may generate and send an emergency signal to a lock or otherwise activate an action within the lock itself which may then initiate an emergency response. Alternatively, the sensor may relay changes in the environment to a controller. A controller then determines if the change in the environment constitutes an emergency. The controller then initiates the emergency response. For example, in one embodiment a sensor may be configured to detect the ambient temperature. The sensor relays the current temperature to a controller, either at specific intervals (i.e. every minute or second), times or constantly. When the controller determines the change in temperature indicates a fire or unsafe temperature, it initiates an emergency response. A sensor may detect at least one stimulus but may also be capable of detecting multiple stimuli. Additionally, a lock may be connected to a plurality of sensors capable of detecting multiple stimuli. It should be appreciated that multiple stimuli may be used together to determine an emergency event. The controller may be integrated into a lock or otherwise associated with a lock.

In some embodiments, it may be desirable for multiple sensors to cooperatively determine an emergency or for a controller using data from multiple sensors to determine an emergency. For example, the combination of a temperature sensor and a smoke detector may both provide information to a lock to determine if there is a fire. The temperature sensor may detect sudden high temperatures that are not indicative of an emergency fire. For example, an oven or stove may cause a lock sensor to detect a temperature above the threshold for a fire, however data from a smoke detector may be used in addition to the temperature data to determine if the event is indicative of an emergency fire. It should be appreciated that this may reduce the risk of false alarms. Alternatively, a locked lock may have a sensor to detect forces, and the system may include a sensor to detect noise. The noise sensor may be able to detect sounds at certain volumes or with certain patterns. This sound data and data from the force sensor is combined in order to distinguish an emergency such as an earthquake from a perpetrator trying to break down a door. Different types and combinations of data may be used to determine a plurality of different emergencies. It should be appreciated that different methods may be used to determine whether received data is indicative of an emergency. For example, data fusion may be used whereby the data is combined in a suitable manner to accurately determine an emergency signal. It should be appreciated that other data processing techniques, such as machine learning or AI may be employed to properly detect an event.

In some embodiments a lock may have a control system that is able to initiate an emergency response upon receiving an emergency signal or upon the controller determining there is an emergency based on a sensor input. Such a response may help improve the safety of building occupants during an emergency event. It should be appreciated that the type of emergency response may correspond to the type of emergency signal. Some emergency responses may initiate a lockdown procedure intended to keep occupants safe while inside a building. Alternatively, some emergency responses may initiate an evacuation procedure intended to get occupants out of a building safely. For example, if a lock receives an emergency signal indicating there is a fire, a system may direct the lock to unlock, or a system may trigger a fire alarm alerting occupants to evacuate a building, or a system may activate a sprinkler system. It should be appreciated that the system may take any combination of the responses or further additional responses. The exact emergency response may vary based on the safety needs of a building, structure, or campus. A system is not limited to one type of emergency response, and it should be appreciated that a lock is capable of different responses depending on the type of emergency signal received. For example, an emergency response for an intruder in a building may involve a different combination of actions taken by the lock compared to an emergency response for a fire. A response for an intruder may involve initiating a lockdown. This may involve doors locking or alerting occupants to shelter in place or contacting first responders.

According to one aspect, the lock system may include a plurality of locks within a building, structure or campus. In this respect, the plurality of locks may form a mesh network, wherein locks are connected to at least one additional lock so that data may transfer between locks. Locks may be in direct communication with other locks in the mesh network or in indirect communication. Locks in the lock system may have a wired or wireless connection. Locks within the system may be capable of detecting and rendering an action based on the type of event and communicating directly with other locks or indirectly through other locks to further locks in the system regarding the event such that the other locks may also render a desired action at that lock. Actions may be taken directly by the lock such as locking or unlocking. Alternatively, actions may be events triggered by a lock such as a fire door closing, or a sprinkler turning on. It should be appreciated that the actions taken by the locks are not limiting. A first lock receiving a signal from a sensor indicating an emergency may respond to an event and thus is considered a primary lock. The primary lock may then communicate directly to one or more secondary locks within the mesh network so that the secondary locks may also take appropriate action, or the primary lock may communicate through one or more secondary locks to additional secondary locks within the mesh network but located outside the range of the primary lock. Locks may be further connected to systems external to the lock network, such as internet networks, existing security systems, telecommunication systems, or emergency services. A lock may be configured to communicate with an external system so that a primary emergency response from the lock may be transmitted as an emergency signal to the external system. The connection may be wired, through telephone lines or fiber optic cables for example. Alternatively, the connection may be wireless, through cellular networks, satellite or radio for example. In this way, the lock need not communicate exclusively within the lock network. It should be appreciated that such a communication with an external network may assist in a rapid response to the emergency from emergency services for example, for example, by allowing the lock to by-pass or otherwise directly communicate with the external system in the event of an emergency.

It should be understood that different locks in the lock system may take different actions. Lock actions may be influenced by several factors including but not limited to, the distance a lock is from an emergency, the functionality of a lock during regular operation, geolocation of the lock in a building, or the type of lock hardware. It should be appreciated that different functionalities can be used based on a specific building's safety needs.

A variety of communication connections are contemplated to enable the locks within the lock systems to send or receive data, signals, or information to and from the lock or to emergency services, or devices outside of the lock system. Locks may have a wired connection such as an Ethernet connection and/or a wireless connection such as radio (e.g., wifi), or Bluetooth®.

Further, in the case of a wireless lock mesh network, the primary lock may communicate an emergency signal to a nearby secondary lock. That secondary lock may then communicate to a further secondary lock that is outside the range of a primary lock. For example, if a primary lock determines there is an emergency, the primary lock may send an emergency signal to a plurality of secondary locks over radio. The secondary lock that receives the signal may initiate an appropriate similar emergency response and then transmit an emergency signal to additional secondary lock(s) located out of range from the primary lock but within range of the secondary lock. This enables the additional secondary lock(s) to initiate suitable emergency responses in situations where it may otherwise be unable to receive the information from the primary lock.

In some embodiments, a primary lock detecting an emergency may initiate a primary emergency response and may take at least one action yet one or more secondary locks may take the same or different actions. In one embodiment, the type of emergency response may vary based on the distance between the locks. For example, the primary lock may detect a fire and initiate an emergency response including activating a nearby sprinkler and unlocking a lock. That primary lock may then send out an emergency signal indicating a fire to additional lock(s) that are within radio communication range. These additional locks may then initiate their own response activating additional nearby sprinklers and unlocking locks and sending out an additional emergency signal to further additional locks. One or more of these additional locks that did not receive the initial emergency signal may initiate a different emergency response where locks are unlocked, but nearby sprinklers are not activated. Other examples are contemplated, as the disclosure is not limited in this regard. That is, the additional lock(s) may initiate the same or a different response.

In some embodiments, it may be desirable for the system to record the location of each lock in the lock system. It should be appreciated that the location of each lock in the lock system may be predetermined when installed and recorded into the system manually. Alternatively, the location of the lock may be recorded automatically when a lock is connected to a network capable of location tracking. It should be appreciated that lock responses may further differ by the location of the lock in the building. The lock locations may recorded into a directory or similar record containing the location of each lock. Alternatively, the location of each lock may be indicated on a map.

In some embodiments, it may be desirable for locks to isolate, partition, or segment, or sequester certain areas of a building or structure by coordinating the locking or unlocking certain locks based on the location of an emergency as part of a location-based response. For example, if an initial responding lock detects a violent emergency in a first location, it may be desirable to initiate an emergency response where the detecting lock may unlock and send a signal to additional locks along the lock mesh network. Signal receiving locks for doors in the same area or room as the violent emergency may unlock. In addition, signal receiving locks in doors in different areas may lock. It should be appreciated that people in the vicinity of the violent emergency are able to evacuate the location, while people outside the vicinity of the violent emergency are secured from the emergency potentially spreading effectively segmenting the emergency from the rest of the building.

Alternatively, it may be desirable if a lock detects a violent emergency, to initiate an emergency response where the detecting lock may unlock if the detecting lock is connected to an external door (i.e. a door for leaving or entering a building), or lock if the detecting lock is connected to an internal door (i.e. a door for going between rooms or areas inside of a building). The detecting lock may send a signal to additional locks along the lock mesh network. Signal receiving locks for external doors in the same area or room as the violent emergency may unlock, while signal receiving locks for internal doors in the same area or room may lock. In addition, locks in doors in different areas may unlock. It should be appreciated that such an arrangement may allow people to entirely evacuate a building while preventing a violent emergency from spreading throughout the building. Alternatively, if the violent emergency occurs outside of the building or structure, all external locks may lock. Alternatively, certain locks may remain locked or unlocked to evacuate people along a desired route to minimize exposure to the emergency event. It should be appreciated that the combination, location, and type of emergency response is not limiting, different location-based lock responses may be utilized for other types of emergencies.

The inventors have further recognized that many emergencies are not single isolated events. For example, violent emergencies may cause, in addition, a fire (or other type of) emergency. Alternatively, emergencies may move within a building structure, or campus causing an initially dangerous areas to become safe, or initially safe areas to become dangerous despite mitigation efforts. The inventors have appreciated that it may be desirable for locks within the mesh network to have adaptable responses such that as the emergency changes, locks may alter their emergency response. For example, if a violent emergency occurs in an initial room, internal locks around the initial room may lock down. However, if the violent emergency spreads past the initial room, it may be desirable for additional locks that may have been in an unlocked state in the lock mesh network to lock to segment off a new area to further contain the emergency. Alternatively, if a violent emergency turns into a fire emergency, some locks in the building may enter an unlocked state, while locks near the violent emergency remain in a locked state to allow people to evacuate the building along a desired rout while avoiding the violent emergency. It should be appreciated that locks in the mesh network may have a plurality of contingency plans controlled either directly by the lock or by a control system.

In some embodiments, if an emergency subsides, it may be advantageous for a validated user to determine if an environment is safe and disable a lock system response. This may be desirable in the event of a false alarm or when an emergency is resolved. Locks in the lock system engaged in an emergency response may initiate an ending response and transition to its non-emergency state. Locks in the system may be in operative communication with other locks whereby an ending signal may be communicated across the mesh network of locks, enabling locks that are located a distance away from the primary lock to disable an emergency response. In this regard, there may be no need to reset each lock individually.

Locks in the lock system may have the ability to validate a user. A user may be validated if they possess predetermined credentials indicating authority to end a response. Credentials may be any type of access control key, for example, an RFID card, a fob, multi-factor authentication, biometric authentication, or a physical key. Accordingly, a lock may have a suitable reader or access control verification system. A validated user may be a first responder, a building administrator, a security officer, or a teacher for example.

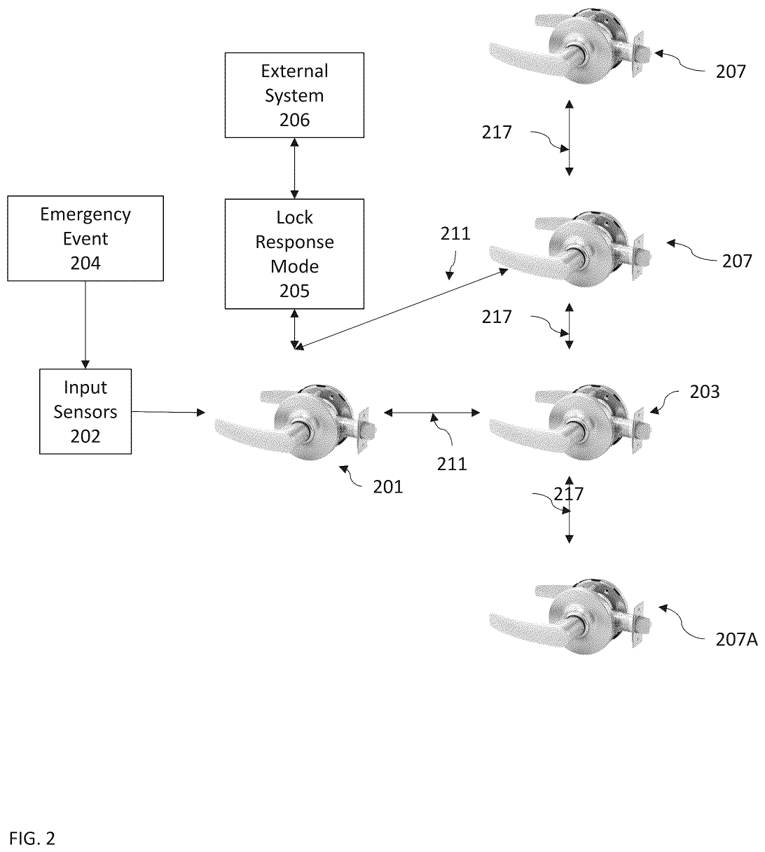

Turning to FIGS. 2-5E, specific non-limiting embodiments are described in further detail. It should be understood that the various systems, components, features, and methods described relative to these embodiments may be used either individually and/or in any desired combination as the disclosure is not limited to only the specific embodiments described herein.

FIG. 2 depicts one embodiment of the system having at least one primary lock 201 connected to at least one sensor 202 so that information can be communicated between the primary lock 201 and the sensor 202. The sensor 202 can detect at least one stimulus in the surrounding environment indicating an emergency event 204. The sensor 202 may be calibrated to a threshold to determine if a stimulus indicates an emergency event 204. Alternatively, a lock 201 may receive information from an input sensor 202 and the lock may be calibrated to determine if the information indicates an emergency event 204. It should be appreciated that the threshold for determining if there is an emergency may be adjustable depending on the type of stimuli received, or the desired application of the system.

In an emergency event 204, the primary lock 201 initiates a primary emergency response and enters a response mode 205, where some action occurs at the lock, for example, the lock enters a “locked” mode (or “unlocked” mode, depending on the type of emergency), thereby increasing occupant safety. In one embodiment, the primary lock 201 of FIG. 2 includes a controller or controller system to process inputs, outputs or actions taken by the primary lock 201. It should be appreciated that by the primary lock detecting an emergency event may lead to a faster response time to the emergency. In addition, the primary lock 201 may initiate actions through the controller that may mitigate the impact of the emergency event. The response may involve directly or indirectly communicating with emergency services, allowing first responders to arrive at the emergency. Alternatively, the response may involve activating fire doors, or emergency alarms. This may be desirable in situations where an emergency occurs without a person initially detecting the emergency. For example, if a fire were to occur inside an unoccupied room in a building, the lock may detect the fire before a person does and initiate an emergency response that may include calling the fire department, activating an alarm, and shutting fire doors in the vicinity of the emergency. It should be appreciated that at least the primary lock 201 may be in further communication with an external system 206 in such a way that when the primary lock 201 enters a response mode 205, the primary lock 201 may transmit an emergency signal to the external system 206. Such a connection may be wired or wireless. It should be appreciated that such a communication with an external network may assist in a rapid response to the emergency from emergency services, for example, by allowing the lock to directly communicate with the external system 206 in the event of an emergency. It should be appreciated that the external system 206 may include internet networks, existing security systems, telecommunication systems, or emergency services.

Additionally, the primary lock 201 may be connected to at least one secondary lock 203 by a connection 211 such that the primary and secondary locks 201 and 203 are able to communicate information between each other. The connection 211 may be wired such as an Ethernet connection, or the connection 211 may be wireless. The primary and secondary locks 201 and 203 may also be able to connect directly without the use of an intermediary source. This enables a primary lock 201 to transmit an emergency signal to a secondary lock 203. Upon receiving an emergency signal, a secondary lock may initiate a secondary emergency response. It should be appreciated that the secondary emergency response may differ from the primary emergency response. For example, in a fire emergency a lock on a fire door in a room with a fire may initiate the fire door to close as a primary emergency response, while a secondary lock on an external door may unlock and automatically open as part of a secondary response upon receiving an emergency signal.

The system may be implemented in a mesh arrangement where the primary and secondary locks 201 and 203 may be able to communicate with any number of additional secondary locks 207. In one embodiment, the primary lock can communicate 211 directly with the further lock(s) 207 or may communicate with the further lock(s) 207 via the secondary lock 203 in a mesh. Information may be sent from the primary lock 201 to the secondary lock 203, then the secondary lock 203 may send the information to the additional secondary lock(s) 207 through additional connections 217. It should also be understood that while not shown, any number of the secondary lock(s) 203 and additional secondary lock(s), 207 may be employed. Such an arrangement allows emergency information from one lock to rapidly spread to other locks in a building or structure. The spread of information may alert occupants of an emergency before an emergency reaches other areas of a building or structure.

Further, it should be understood that any of the features of the primary lock 201 may be employed in the secondary 203 or additional secondary locks 207. This enables additional secondary lock(s) 207A outside of the communication range of the primary lock 201 to receive an emergency signal and initiate an additional secondary emergency response without being in the immediate vicinity of an emergency event 204 or a primary lock 201 detecting an emergency event 204. This further enables additional secondary lock(s) 207 to initiate emergency responses based on the distance from a primary lock 201 and emergency event 204. It should be appreciated that locks may transmit and receive signals to and from multiple locks, ensuring that the emergency signal can continue to be relayed if one or more locks malfunction.

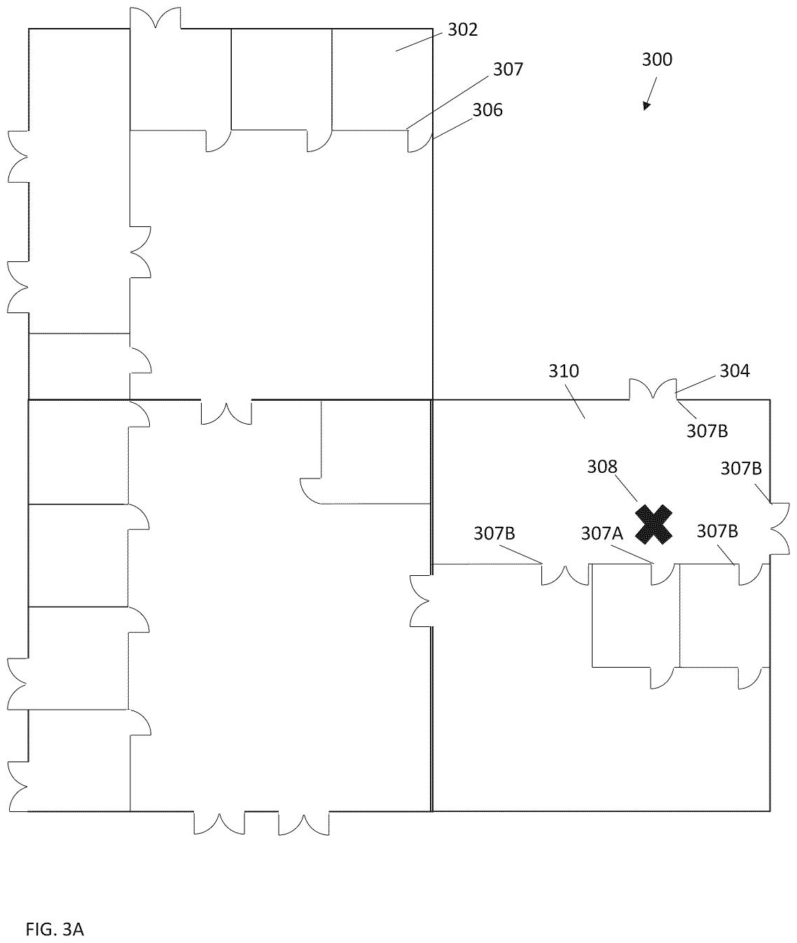

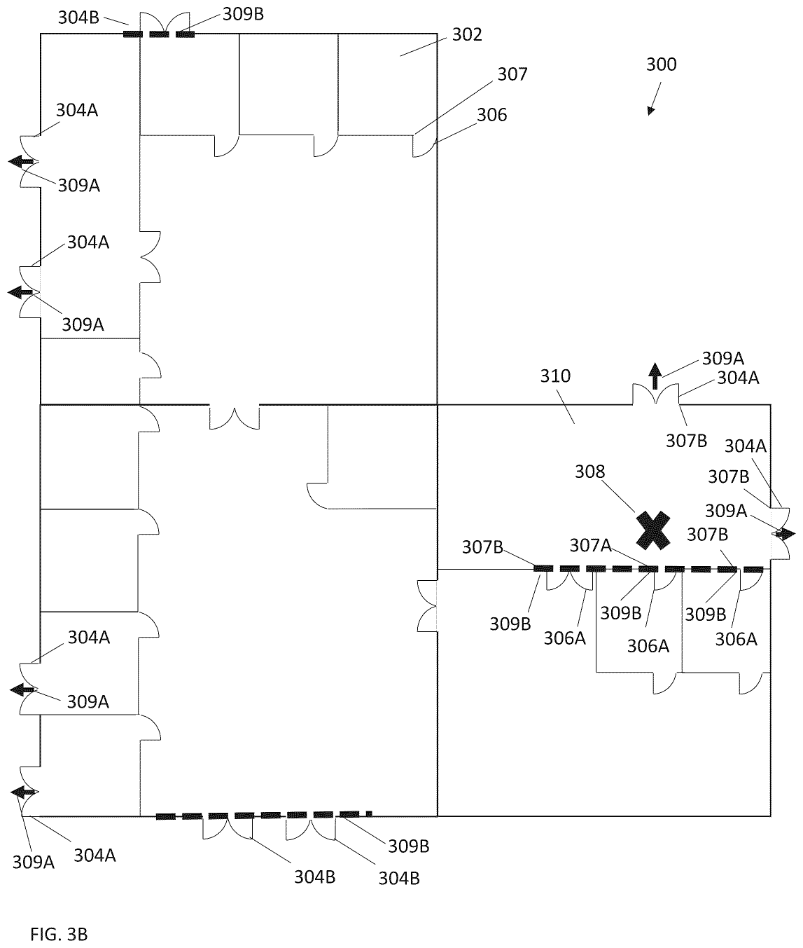

FIG. 3A illustrates a schematic of a building 300 having one embodiment of the lock to lock system incorporated into the building locks. The building may have a plurality of rooms 302. Some of the rooms 302 have at least one external door 304 (a door leading to the outside of the building). In addition, some of the rooms 302 may have at least one internal door 306 (a door leading to another room inside of the building), or both internal and external doors. The doors 304 and 306 may have a lock 305 as part of a lock to lock system, wherein the locks may be connected wired or wirelessly to one another, forming a mesh network of locks where the locks may transmit data between locks. The locks may further be connected to an additional network or central control system, allowing the locks to transmit data outside of the mesh network. It should be appreciated that it is not necessary for every door to have a lock or a lock that is a part of the mesh network. It may be desirable for each lock to further be associated with a location inside the building, or a type of door to allow for a system to identify a door. For example, some doors may be identified as internal or external locks. Alternatively, doors may be identified as fire doors, automatic doors, or swing doors.

FIG. 3A further illustrates an emergency event 308 occurring inside a room 310. The emergency event 308 may be a violent event. A primary lock 307A may be the first lock to detect the emergency event 308 due to the proximity of the primary lock 307A to the emergency event 308. The primary lock 307A may detect a sudden noise, change in temperature, or vibration for example. It should be appreciated that the exact event or stimuli causing the primary lock 307A to detect the emergency event 308 is not limiting. The primary lock 307A may communicate with secondary locks 307B. The primary lock 307A and secondary locks 307B may further communicate with additional locks within the building, so that the locks enter an emergency response. The locks communicating, may effectively alert the entire building of the emergency event 308 even in rooms far away from the room 310 having an emergency. It should be appreciated that the response of the primary lock, may be the same or different from the response of the other locks in the building.

FIG. 3B illustrates the building with the locks having detected the emergency 308 entering a response mode 309. The locks may have similar or different response modes 309. It should be appreciated that there may be a plurality of factors that change the response mode such as the type of emergency, the location of the lock, the type of door the lock is connected to, or other factors. In a violent event, as illustrated in FIG. 3B, it may be desirable to isolate the room where the violent event is occurring and evacuate the rest of the building. Upon a lock 307 receiving an emergency signal from another lock, or directly detecting the emergency 308, a lock may enter an emergency response 309. It may be desirable for locks 307B on internal doors 306A in the room 310 having the emergency event 308 to lock the respective doors. Locked doors are depicted by dashed lines 309B. This may isolate the room 310 having the emergency event from the rest of the building 300, so that the violent event does not spread. Some external doors 304A may enter a response mode upon receiving an emergency signal or detecting an emergency where the lock opens the door as depicted by arrows 309A. Other external doors 304B may enter a response mode upon receiving an emergency signal where the lock locks the doors as depicted by dashed lines 309B. It should be appreciated that by opening some external doors and locking other external doors, occupants in the building away from the emergency event 308 are evacuated out of the building to an opposite side of the emergency event 308. Occupants in the room 310 having the emergency event may evacuate any nearby external door.

It should be appreciated that different locks may initiate different responses depending on the type and location of the emergency. In addition, different buildings may have different lock or door orientations and thus may need to alter lock responses to properly meet the needs of the building. In addition, different response scenarios may be determined or planned by a user or by a central control system.

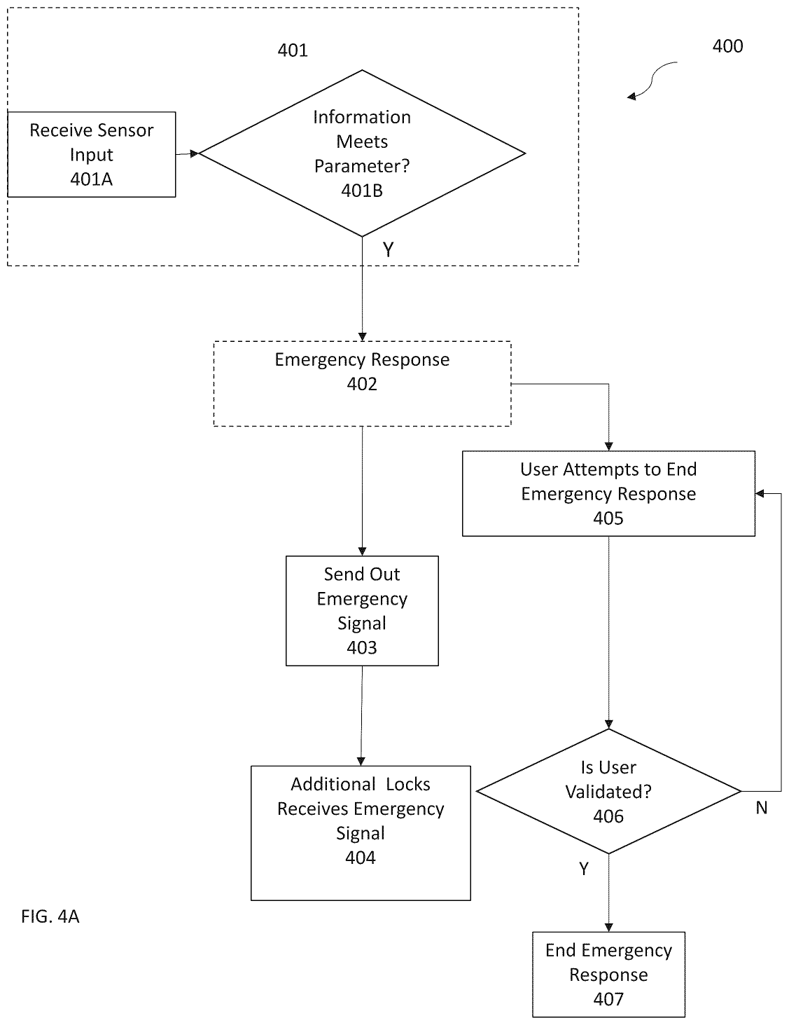

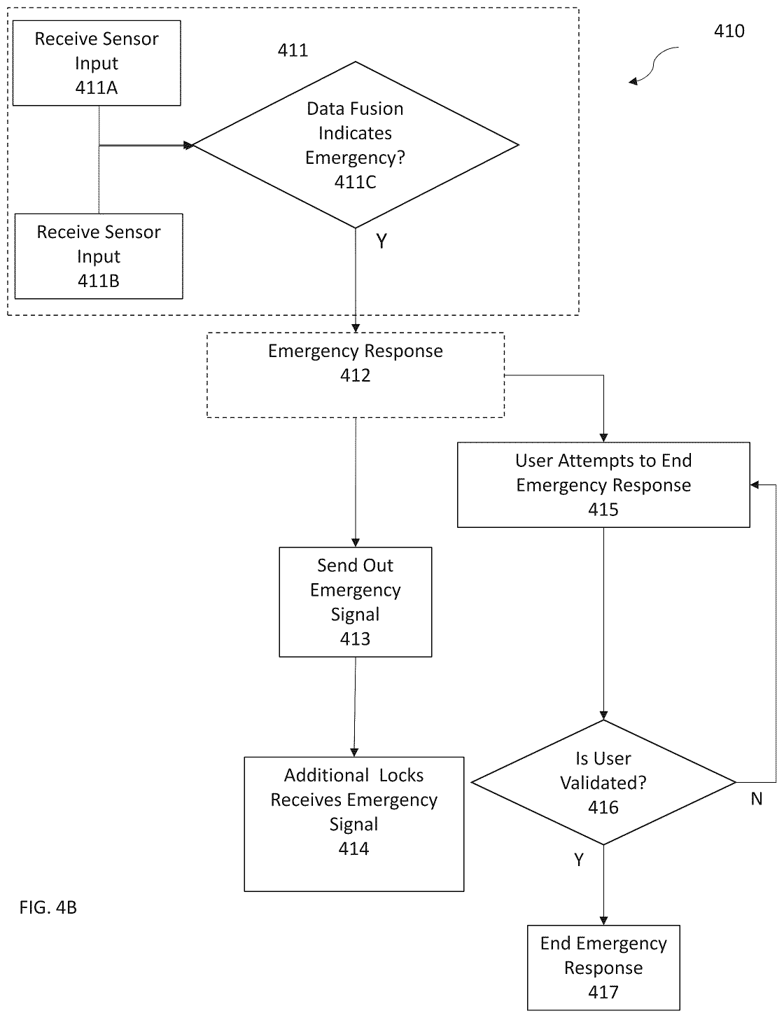

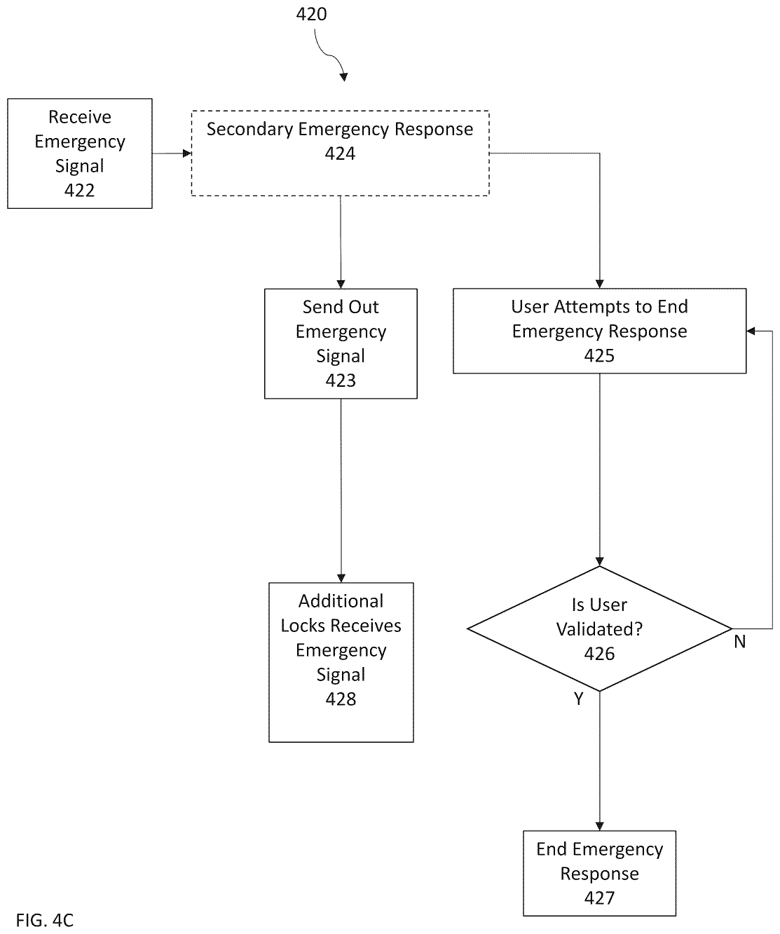

FIG. 4A depicts a flow diagram 400 of one embodiment of the actions taken by a lock in the lock to lock system in response to an emergency. At least some of the actions described in this flow diagram may be performed by the primary door lock. A detection and determination arrangement is shown at 401. A sensor (e.g., the sensor 202 described in FIG. 2) receives information or stimuli from the environment 401A. A determination is made at 401B, whether the information meets predetermined parameters or a predetermined threshold that indicates a potential emergency situation. It should be appreciated that it may be desirable for the threshold for determining if there is an emergency to be based on received information or stimuli to be adjusted. Different buildings or environments may have a higher risk for certain emergencies compared to other locations. For example, a building in a hot arid climate may have sensors with a relatively low threshold for detecting heat to determine if there may be a fire due to a high fire risk. Alternatively, a chemical manufacturing plant may have a relatively high threshold for detecting toxic gasses, due to high amounts of toxic gases in the ambient air. If an emergency is determined, a primary emergency response is initiated at 402 corresponding to the type of emergency. The emergency response may mitigate the risk of the emergency on occupants of a building. In some embodiments, it may be desirable for the emergency response to help occupants evacuate a building. Alternatively, in some embodiments, it may be desirable for the emergency response to help occupants shelter in place. At 403, an emergency signal may be sent to other/additional lock(s) 404 such that, the additional locks may be secondary locks and may enter a secondary emergency response state. It should be appreciated that some emergency responses in one building may differ depending on where the response is in relation to the emergency event or the type of emergency event. Some responses in a building may help some occupants evacuate, while other response in the same building may help some occupants shelter in place.

Once the emergency response begins, a user may attempt to end the emergency response, as shown at 405 of FIG. 4A. The system may then determine if the user is validated 406. That is, the system can aid in determining whether the user has the proper credentials (e.g., the user is a first responder, a teacher or administrator, etc.) to end the emergency response. Such a case may be desirable for a false alarm, or an override to the automatic response. If the user is validated, the emergency response ends 407. It should be appreciated that any form of validation is within the scope disclosed herein. For example, the validation may be but is not limited to physical validation methods such as a key or biometric, or digital such as a credential with a reader 408. It should be further appreciated that the system may require a validated user to end the emergency response to prevent a perpetrator or bad actor from prematurely ending an emergency response.

FIG. 4B illustrates an alternative response 410 of a lock to an emergency. A detection and determination arrangement is shown at 411. Multiple sensors (e.g., sensors 202 described in FIG. 2) receive information or stimuli from the environment at 411A and 411B. The data may be fused to accurately determine if there is an emergency at 411C based on predetermined thresholds. It should be appreciated that different data fusion methods and algorithms are considered. In addition, it should be appreciated that the amount of data, and number of types of data received is not limiting. Data from a plurality of different sensors may be used to help determine an emergency event and distinguish different types of emergencies. For example, a lock may be connected to a pressure, sound, and vibration sensor. A combination of data from the three sensors may be allow the lock to distinguish weather events where a change in pressure, sound and potential vibrations may indicate a potential storm or tornado. This may differ from a violent emergency event, where there may only by a sudden change in sound accompanying excessive vibrations. If an emergency is determined, a primary emergency response is initiated at 412 corresponding to the type of emergency. At 413, an emergency signal may be sent to other/additional lock(s) 414 such that, the additional locks may be secondary locks may enter a secondary emergency response state. Once the emergency response begins, a user can attempt to end the emergency response, as shown at 415 of FIG. 4B. The system then determines if the user is validated 416. That is, the system can aid in determining whether the user has the proper credentials (e.g., the user is a first responder, a teacher or administrator, etc.) to end the emergency response. Such a case may be desirable for a false alarm, or an override to the automatic response. If the user is validated, the emergency response ends 417.

As discussed above, and as shown in the flow diagram 420 of FIG. 4C, secondary locks in the mesh may receive an emergency signal 422 from other locks in a lock mesh network and then initiate an additional emergency response at 424. In such a case, flow diagram 420 represents one of the secondary locks. Upon receiving an emergency signal 422 an additional lock may initiate a secondary emergency response 424. Upon initiating a secondary emergency, the system may send out yet another emergency signal 423 to further additional secondary locks 429. It should be understood that the above may occur for any number of additional secondary locks. The secondary emergency response may be similar or different to the initial emergency response depending on the type of emergency and location of the secondary lock relative to the initial emergency event.

A user may also attempt to end an emergency response in additional locks, as shown at 425 of FIG. 4C. The system then determines if the user is validated 426. That is, the system can aid in determining whether the user has the proper credentials (e.g., the user is a first responder, a teacher or administrator, etc.) to end the emergency response. Such a case may be for a false alarm, or an override to the automatic response. If the user is validated, the emergency response ends 427. It should be appreciated that any form of validation is within the scope disclosed herein. For example, the validation may be but is not limited to physical methods such as a key or biometric, or digital such as a credential with a reader 428.

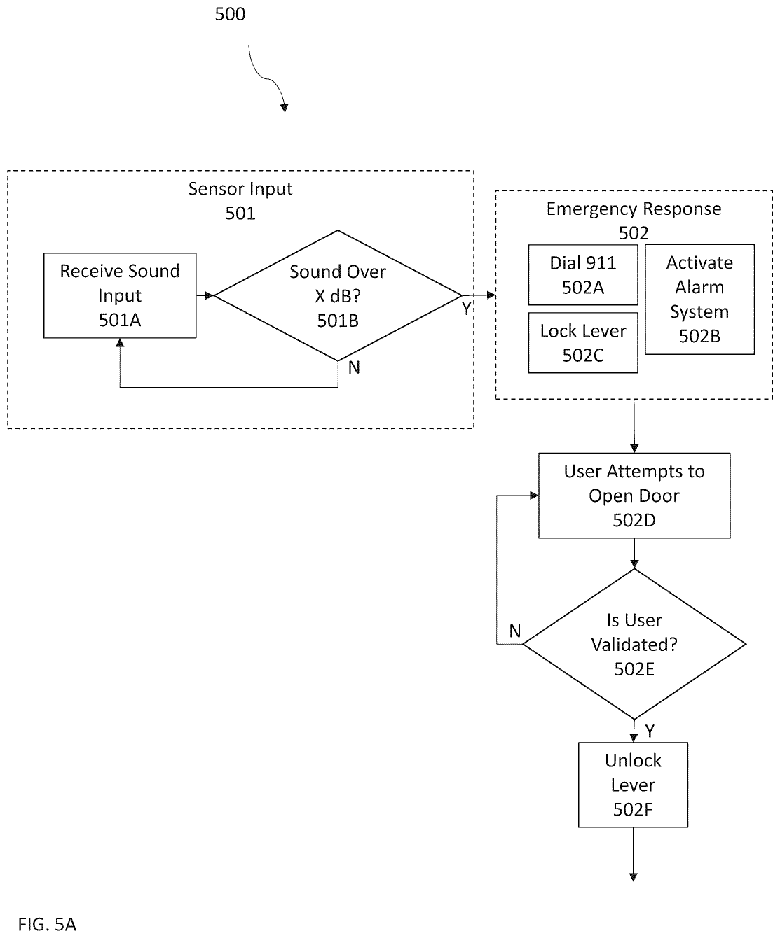

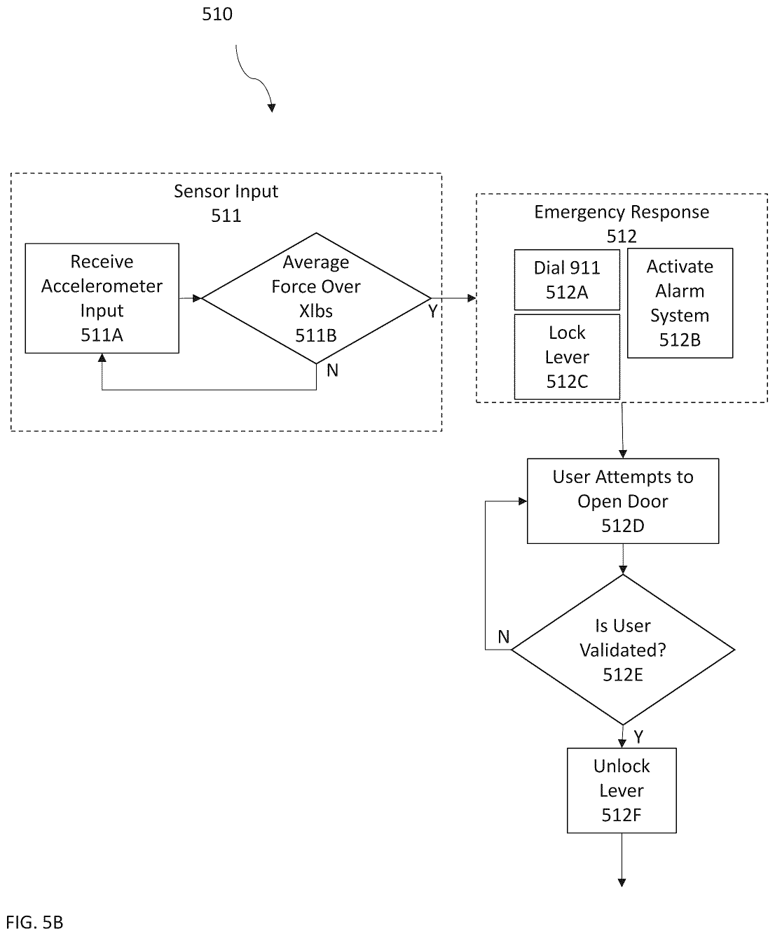

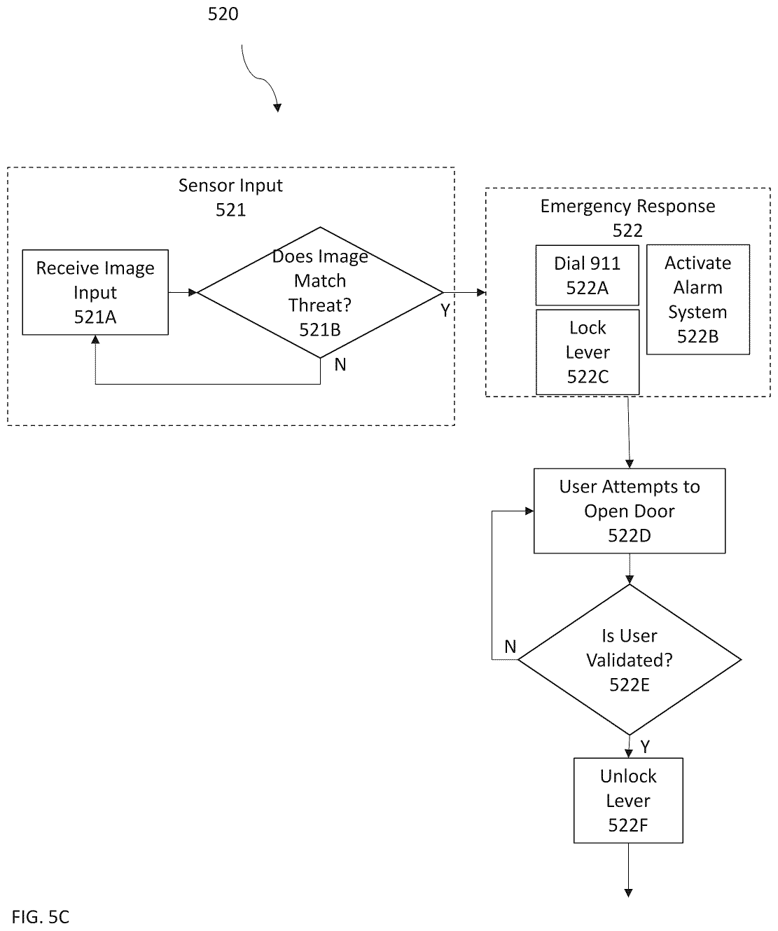

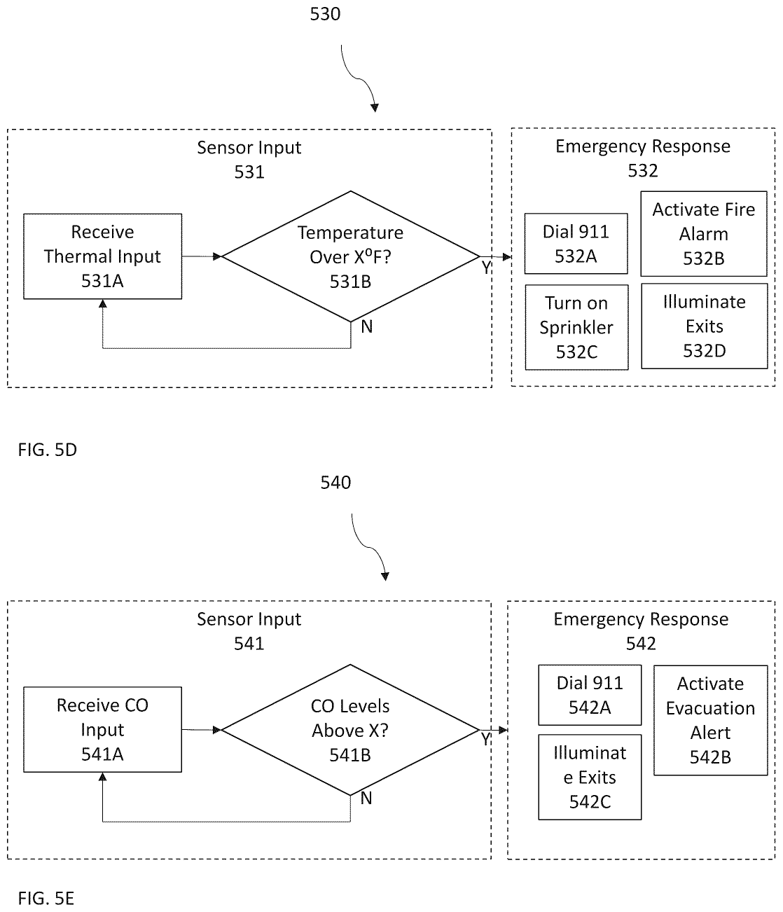

It should be appreciated that a lock within the mesh network may have at least one sensor input and at least one emergency response. The sensor may detect a variety of inputs and the response can vary depending on the desired safety precautions. FIG. 5A shows one embodiment of a sensor input and a respective response 500. In this embodiment the sensor 501 detects sound inputs 501A if a sound is above a predetermined threshold 501B, the system may initiate an emergency response 502 and may send out an emergency signal. In this embodiment the emergency response 502 may involve at least one of the following actions: sending an alert to emergency services (e.g. cellular or radio communication to 911, or some other emergency response service) 502A, activating a lockdown procedure alarm system 502B, or locking the lever 502C. If a user attempts to open the door 502D, the system then determines if the user is validated 502E. If the user is validated the lever unlocks 502F. The validation may be but is not limited to physical methods such as a key or biometric, or digital such as a credential.

FIG. 5B shows another embodiment of a sensor input and a respective response 510. In this embodiment the sensor 511 detects accelerometer inputs 511A, if a force applied to the lock is above a predetermined threshold 511B, the system may initiate an emergency response 512 and may send out an emergency signal. In this embodiment the emergency response 512 may involve at least one of the following actions: sending an alert to emergency services (e.g. cellular or radio communication to 911 or some other emergency response service) 512A, activating an alarm system 512B, or locking the lever 512C. If a user attempts to open the door 512D, the system then determines if the user is validated 512E. If the user is validated the lever unlocks 512F. The validation may be but is not limited to physical methods such as a key or biometric, or digital such as a credential.

FIG. 5C shows another embodiment of a sensor input and a respective response 520. In this embodiment the sensor 521 captures images or videos of an area as an input 521A if an image or video matches a predetermined threat 521B, the system may initiate an emergency response 522 and may send out an emergency signal to other locks. In this embodiment the emergency response 522 may involve at least one of the following actions: sending an alert to emergency services (e.g. cellular or radio communication to 911 or some other emergency response service) 522A, activating an alarm system 522B, or locking the lever 522C. If a user attempts to open the door 522D, the system then determines if the user is validated 522E. If the user is validated the lever unlocks 602F. The validation may be but is not limited to physical methods such as a key or biometric, or digital such as a credential.

FIG. 5D shows another embodiment of a sensor input and a respective response 530. In this embodiment the sensor 531 detects thermal changes as an input 531A if a thermal change indicates a nearby fire 531B, the system may initiate an emergency response 532 and may send out an emergency signal to other locks. In this embodiment the emergency response 532 may involve at least one of the following actions: sending an alert to emergency services (e.g. cellular or radio communication to 911 or some other emergency response service) 532A, activating a fire alarm system 532B, turning on a sprinkler system 532C or illuminating exit paths 532D.

FIG. 5E shows another embodiment of a sensor input and a respective response 540. In this embodiment the sensor 541 may detect hazards in the air such as carbon monoxide (CO) as an input 541A if a concentration of hazardous materials in the air exceeds a predetermined threshold, the system may initiate an emergency response 542 and may send out an emergency signal to other locks. In this embodiment the emergency response 542 may involve at least one of the following actions: sending an alert to emergency services (e.g. cellular or radio communication to 911 or some other emergency response service) 542A, activating an evacuation procedure and alarm system 542B, or illuminating exit paths 542C.

The above embodiments should not be considered limiting. The system may have any number of the above sensors or emergency responses in varying combinations. The system may also have sensors and emergency responses not mentioned. It should further be understood that the locks in the lock system may utilize data fusion to combine data and information from multiple sensors or types of stimuli to accurately detect and determine an emergency.

The previously described embodiments may apply to locks of a variety of functionality. The functionality of a lock may vary based on the type locking hardware, or access system. The functionality may also vary depending on the normal operation of a lock. For example, a lock in the mesh network may be a cylinder lock operated by a lever, a push bar exit device, or a mortise lock. Similarly, the doors connected to the lock systems in the previous embodiments may be any type of door, a building may also have different combinations of doors. For example, the door may be a single or double swing door, a sliding door, a rotating door, or a garage door. The lock system may also control various aspects of a door including a door operator, or a magnetic latch.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only. What is claimed is:

1. A lock system comprising:
a plurality of locks;
a primary lock being one of the plurality of locks, wherein the primary lock comprises a primary lock controller;
at least one sensor in communication with the primary lock controller, the at least one sensor being capable of detecting at least one stimulus and capable of transmitting stimulus data to the primary lock;
the primary lock controller being capable of activating at least one primary emergency response and generating at least one emergency signal upon receiving information from the data indicating an emergency; and
at least one secondary lock being another one of the plurality of locks, the at least one secondary lock comprising a corresponding at least one secondary lock controller;
the primary lock controller and the secondary lock controller being in direct communication with each other, the at least one secondary lock controller being capable of receiving an emergency signal transmitted from the primary lock controller, the at least one secondary lock controller being capable of activating at least one secondary emergency response upon receiving the emergency signal from the primary lock controller.

2. The lock system according to claim 1, wherein the at least one primary emergency response corresponds to the at least one stimulus received by the sensor.

3. The lock system according to claim 1, wherein the at least one primary emergency response is equivalent to the at least one secondary response.

4. The lock system according to claim 1, wherein the at least one primary emergency response differs from the at least one secondary response.

5. The lock system according to claim 4, wherein the emergency signal causes the at least one primary emergency response to differ from the at least one secondary emergency response.

6. The lock system according to claim 4, wherein the primary lock is a distance from the secondary lock;
the distance causing the at least one primary emergency response to differ from the at least one secondary response.

7. The lock system according to claim 1, wherein the primary emergency response alters a primary lock function of the primary lock, and the secondary emergency response alters a secondary lock function of the secondary lock.

8. The lock system according to claim 1, wherein the at least one primary emergency response initiates an evacuation procedure.

9. The lock system according to claim 1, wherein the at least one primary emergency response initiates a lockdown procedure.

10. The lock system according to claim 1, wherein at least one of the plurality of locks are in further communication with an external system, wherein the at least one primary emergency response further comprises transmitting at least one emergency signal to the external system.

11. The lock system according to claim 1, wherein the plurality of locks form a mesh network.

12. The lock system according to claim 11, wherein the mesh network comprises at least one additional secondary lock being another one of the plurality of locks, the at least one additional secondary lock having an additional secondary lock controller, the at least one secondary lock controller and the at least one additional secondary lock controller being in direct communication with each other, the at least one additional secondary lock controller being capable of receiving a secondary emergency signal transmitted from the secondary lock controller, the at least one additional secondary lock controller being capable of activating at least one additional secondary emergency response upon receiving the secondary emergency signal from the at least one secondary lock.

13. The lock system according to claim 1, wherein at least one of the plurality of locks is an ending lock engaged in an emergency response, the ending lock having an ending lock controller, the ending lock controller receiving an ending input indicating an end of the emergency so that the ending lock transitions from the emergency response into an ending response.

14. The lock system according to claim 13, wherein the ending lock controller provides an output indicating the end of the emergency to at least one lock controller of a lock of the plurality of locks in direct connection to the ending lock.

15. The lock system according to claim 13, wherein the ending input is provided by a user, said user being validated by the lock system.

16. The lock system of claim 1 wherein the at least one sensor comprises a first sensor and a second sensor, wherein the first sensor is capable of detecting a first stimulus and the second sensor is capable of detecting a second stimulus, wherein the lock system generates an emergency response based on a fusion of the data from the at least one stimulus and the second stimulus.

17. A responding lock within a lock system, the lock system including a plurality of locks, one of the plurality of locks being a primary lock and another of the plurality of locks being a secondary lock, the primary lock being capable of activating at least one primary emergency response based upon input from at least one sensor capable of detecting at least one stimulus indicating an emergency, the responding lock configured to be in communication with the primary lock and configured to receive an emergency signal transmitted from the primary lock, the secondary lock being capable of activating at least one secondary emergency response upon receiving the emergency signal from the primary lock.

18. The responding lock of claim 17, wherein the responding lock is configured to activate at least one emergency response based upon a sensor input from at least one additional sensor capable of detecting at least one stimulus.

19. The responding lock of claim 18, wherein the responding lock is configured to be in communication with the secondary lock, the responding lock configured to transmit a secondary emergency signal to the secondary lock and a primary emergency signal to the primary lock, so that the emergency signal activates at least one primary emergency response by the primary lock and at least one secondary emergency response by the secondary lock.

20. The responding lock of claim 19, wherein the responding lock in an emergency response, is configured to receive an ending input indicating an end of the emergency so that the responding lock transitions from the emergency response into an ending response.

21. The responding lock of claim 20, wherein the responding lock is configured, based on the ending input, to generate an ending signal and transmit the ending signal to the primary lock and the secondary lock so that the primary and secondary locks enter the ending response.

22. The lock system of claim 17, wherein the at least one primary emergency response, and the at least one secondary emergency response are coordinated to lock a plurality of doors within a building to sequester a first area having an emergency within the building from a second area within the building.
